(19) United States
(12) Patent Application Publication
(10) Pub. No.: US 2019/0205863 A1
(43) Pub. Date: Jul. 4, 2019

(54) ELECTRONIC DEVICE AND METHOD FOR PROVIDING PAYMENT SERVICE

(71) Applicant: Samsung Electronics Co., Ltd., Suwon-si, Gyeonggi-do (KR)

(72) Inventors: Jun-Kyoung SHIN, Gumi-si (KR); Choong-Hoon KIM, Gumi-si (KR); Sung-Jun KIM, Daegu (KR)

(21) Appl. No.: 16/331,395

(22) PCT Filed: Sep. 7, 2017
(86) PCT No.: PCT/KR2017/009831

§ 371 Date: Mar. 7, 2019

(30) Foreign Application Priority Data
Sep. 9, 2016 (KR) 10-2016-0116334

(51) Int. Cl. G06Q 20/32; G06Q 20/34; G06Q 20/38; H04W 4/02

(52) U.S. Cl. CPC G06Q 20/3221; G06Q 20/34; G06Q 20/3278; H04W 4/02; G06Q 20/382

(57) ABSTRACT

The present invention relates to an electronic device and, more particularly, to an electronic device and a method for providing a payment service in the electronic device. To this end, the present invention provides an electronic device for providing a payment service, comprising: a display; a storage unit for storing a plurality of security elements; a communication interface for performing communication with a near field communication (NFC) reader; and a processor, wherein the processor may be configured to: parse payment information during installation of a first security element; check whether the first security element collides with a previously stored second security element, on the basis of the parsed payment information; output a pop-up window on the display when the first security element collides with the second security element; and when the first security element is selected through the output pop-up window, configure a user interface and configure a routing table including the first security element and a corresponding protocol.

### CROSS-REFERENCE TO RELATED APPLICATION(S)

This application is a National Phase Entry of PCT International Application No. PCT/KR2017/009831, which was filed on Sep. 7, 2017, and claims priority to Korean Patent Application No. 10-2016-0116334, which was filed on Sep. 9, 2016, the contents of which are incorporated herein by reference.

### BACKGROUND

### 1. Field

The present disclosure relates generally to an electronic device and, more particularly, to an electronic device for providing a payment service and a method therefor.

### 2. Description of the Related Art

Recently, various services and additional functions provided by electronic devices have been gradually expanded. To increase the effective value of the electronic devices and to satisfy various user demands, communication service providers or electronic device manufacturers are competitively developing electronic devices that provide various functions that are distinct from other companies.

As these electronic devices are developed, technology that provides a payment service using the electronic device has been developed recently. In order to provide a mobile payment service using an electronic device, a payment scheme needs to be determined. Payment schemes include an Iso-Dep scheme, which is a near field communication (NFC) card mode service provided in Android, and a Mifare-based scheme. Currently, the market share of the Mifare scheme is higher than that of the Iso-Dep scheme.

### SUMMARY

Conventionally, an electronic device provides a user interface to a user only for an Iso-Dep scheme, and may not provide a user interface for a Mifare scheme, thus the user is incapable of changing security elements since the security elements are determined in advance. For the reason above, a user may become confused and it may be difficult to understand how to use the interface, as malfunctions may occur unintentionally.

Therefore, there is a desire to provide a better mobile payment service to a user by providing a user interface similar to that of currently supported services for the service based on the Mifare scheme which is not supported by the Android platform.

The present disclosure relates to an electronic device and, more particularly, to an electronic device for providing payment service and a method therefor.

In accordance with an aspect of the present disclosure, an electronic device for providing payment service is provided. The electronic device may include a display, a storage unit configured to store a plurality of security elements, a communication interface configured to communicate with a near field communication (NFC) reader, and a processor. The processor is configured to perform: parsing payment information while installing a first security element; identifying whether the first security element collides with a previously stored second security element, on the basis of the parsed payment information; outputting a popup via the display when the first security element and the second security element collide; configuring a user interface when the first security element is selected via the output popup; and configuring a routing table including the first security element and a corresponding protocol.

In accordance with an aspect of the present disclosure, a method of providing payment by an electronic device including a plurality of security elements is provided. The method may include: parsing payment information while installing a first security element; identifying whether the first security element collides with a previously stored second security element, on the basis of the parsed payment information; outputting a popup when the first security element and the second security element collide; configuring a user interface when the first security element is selected via the output popup; and configuring a routing table including the first security element and a corresponding protocol.

In accordance with an aspect of the present disclosure, a computer-readable storage medium that stores programs including instructions for providing a payment service by an electronic device is provided. The computer-readable storage medium may include a first instruction set for parsing payment information while installing a first security element; a second instruction set for identifying whether the first security element collides with a previously stored second security element on the basis of the parsed payment information; a third instruction set for outputting a popup when the first security element and the second security element collide; a fourth instruction set for configuring a user interface when the first security element is selected via the output popup; and a fifth instruction set for configuring a routing table including the first security element and a corresponding protocol.

According to various embodiments of the present disclosure, there is provided an electronic device that provides a payment service and a method therefor, whereby payment services of various types can be used. Also, an Iso-Dep-based payment service and a Mifare-based payment service are provided, whereby convenience of users may be improved. By providing a user interface including an Iso-Dep-based security element and a Mifare-based security element, users may easily use a mobile payment service.

### BRIEF DESCRIPTION OF THE DRAWINGS

FIG. 1 is a diagram illustrating an electronic device 101 in a network environment 100, according to various embodiments.

FIG. 2 is a block diagram illustrating an electronic device 201 according to various embodiments.

FIG. 3 is a block diagram of a program module according to various embodiments.

FIG. 4 is a block diagram illustrating a short-range wireless communication system according to various embodiments of the present disclosure.

FIG. 5 is a flowchart illustrating a process of installing a security element for payment in an electronic device according to an embodiment of the present disclosure.

FIG. 6A is a diagram illustrating a user interface in which a plurality of Iso-Dep-based security elements and a plurality of Mifare-based security elements are installed according to an embodiment of the present disclosure;

FIG. 6B is a diagram illustrating the case in which a collision with a previously installed security element occurs while a Mifare-based security element is installed according to an embodiment of the present disclosure;

FIG. 6C is a diagram illustrating the case in which a Mifare-based security element is installed and is activated according to an embodiment of the present disclosure;

FIG. 6D is a diagram illustrating the case in which a Mifare-based security element is installed but is not activated according to an embodiment of the present disclosure;

FIG. 7 is a flowchart illustrating a process in which an electronic device provides a payment service according to an embodiment of the present disclosure;

FIG. 8A is a diagram illustrating an Iso-Dep-based payment service provided in an electronic device according to an embodiment of the present disclosure; and

FIG. 8B is a diagram illustrating an Iso-Dep-based payment service provided in an electronic device according to an embodiment of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., Central Processing Unit (CPU) or Application Processor (AP)) that can perform the corresponding operations by executing one or more software programs stored in a memory device.

The terms used herein are merely for the purpose of describing particular embodiments and are not intended to limit the scope of other embodiments. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The smart home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, a charging device and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an Automatic Teller's Machine (ATM) in banks, Point Of Sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

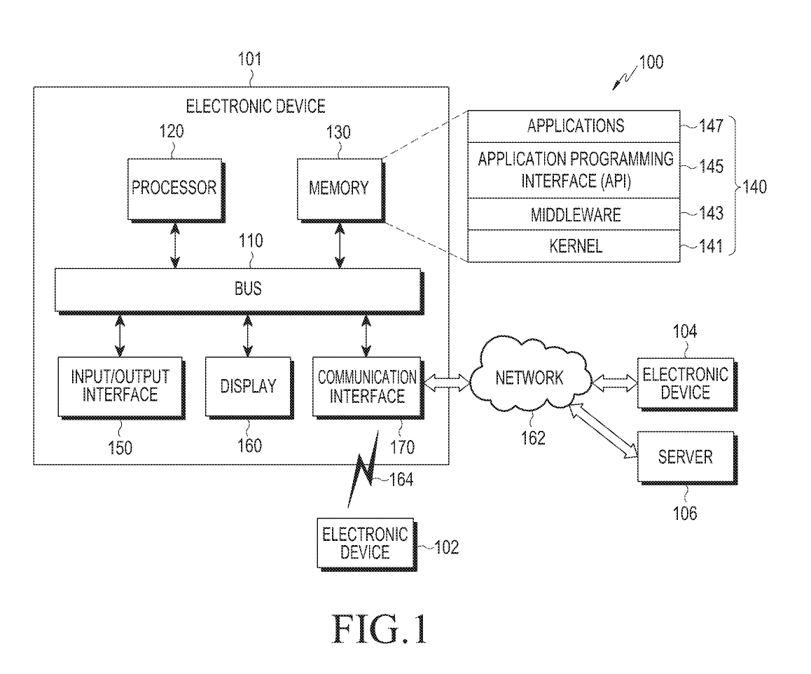

An electronic device 101 within a network environment 100 according to various embodiments will be described with reference to FIG. 1

The electronic device 101 may include a bus 110, a processor 120, a memory 130, an input/output interface 150, a display 160, and a communication interface 170. In some embodiments, the electronic device 101 may omit at least one of the elements, or may further include other elements.

The bus 110 may include, for example, a circuit that interconnects the components 110 to 170 and delivers communication (for example, a control message and/or data) between the components 110 to 170.

The processor 120 may include one or more of a Central Processing Unit (CPU), an Application Processor (AP), and a Communication Processor (CP). The processor 120, for example, may carry out operations or data processing relating to the control and/or communication of at least one other element of the electronic device 101.

The memory 130 may include volatile and/or non-volatile memory. The memory 130 may store, for example, instructions or data relevant to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data.

Furthermore, the middleware 143 may process one or more task requests, which are received from the application programs 147, according to priorities thereof. For example, the middleware 143 may assign priorities for using the system resources (for example, the bus 110, the processor 120, the memory 130, or the like) of the electronic device 101 to one or more of the application programs 147. For example, the middleware 143 may perform scheduling or loading balancing on the one or more task requests by processing the one or more task requests according to the priorities assigned to the one or more application programs.

The API 145 is an interface through which the applications 147 control functions provided from the kernel 141 or the middleware 143, and may include, for example, at least one interface or function (for example, instruction) for file control, window control, image processing, or text control.

The input/output interface 150 may function as, for example, an interface that can forward instructions or data, which are input from a user or an external device, to the other element(s) of the electronic device 101. Furthermore, the input/output interface 150 may output instructions or data, which are received from the other element(s) of the electronic device 101, to the user or the external device.

The display 160 may include, for example, a liquid crystal display (LCD), a light-emitting diode (LED) display, an organic light-emitting diode (OLED) display, a micro electro mechanical systems (MEMS) display, or an electronic paper display. The display 160 may display, for example, various types of contents (e.g., text, images, videos, icons, or symbols) to the user. The display 160 may include a touch screen and may receive, for example, a touch, gesture, proximity, or hovering input using an electronic pen or the user's body part.

The communication interface 170 may establish, for example, communication between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may use, for example, at least one of Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), Global System for Mobile Communications (GSM), and the like, as a cellular communication protocol. In addition, the wireless communication may include, for example, short range communication 164. The short range communication 164 may include at least one of, for example, Wi-Fi, Bluetooth, Near Field Communication (NFC), Global Navigation Satellite System (GNSS), and the like. The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), a Plain Old Telephone Service (POTS), and the like. The network 162 may include at least one of a communication network such as a computer network (e.g., a LAN or a WAN), the Internet, and a telephone network.

Each of the first and second external electronic devices 102 and 104 may be of the same or a different type from the electronic device 101. According to an embodiment, the server 106 may include a group of one or more servers. According to various embodiments, all or some of the operations executed in the electronic device 101 may be executed in another electronic device or a plurality of electronic devices (for example, the electronic devices 102 and 104 or the server 106). According to an embodiment, when the electronic device 101 has to perform some functions or services automatically or in response to a request, the electronic device 101 may make a request for performing at least some functions relating thereto to another device (for example, the electronic device 102 or 104 or the server 106) instead of performing the functions or services by itself or in addition. Another electronic device (for example, the electronic device 102 or 104, or the server 106) may execute the requested functions or the additional functions, and may deliver a result thereof to the electronic device 101. The electronic device 101 may provide the received result as it is, or may additionally process the received result to provide the requested functions or services. To this end, for example, cloud computing, distributed computing, or client-server computing technology may be used.

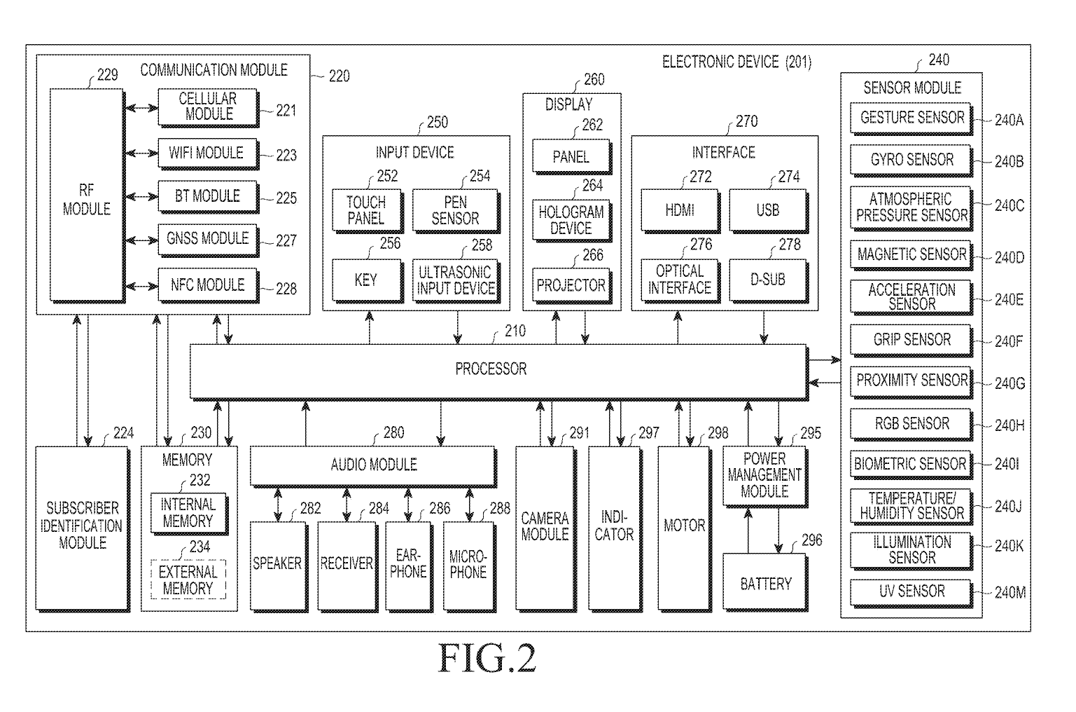

FIG. 2 is a block diagram of an electronic device 201 according to various embodiments.

The electronic device 201 may include, for example, the whole or part of the electronic device 101 illustrated in FIG. 1. The electronic device 201 may include at least one Application Processor (AP) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software elements connected thereto and may perform various data processing and operations by driving an operating system or an application program. The processor 210 may be implemented by, for example, a System on Chip (SoC). According to an embodiment, the processor 210 may further include a Graphic Processing Unit (GPU) and/or an image signal processor. The processor 210 may also include at least some of the elements illustrated in FIG. 2 (for example, a cellular module 221). The processor 210 may load, in a volatile memory, instructions or data received from at least one of the other elements (for example, a non-volatile memory) to process the loaded instructions or data, and may store various types of data in the non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (for example, a GPS module, a Glonass module, a Beidou module, or a Galileo module), an NFC module 228, and a Radio Frequency (RF) module 229.

The cellular module 221 may provide, for example, a voice call, a video call, a text message service, an Internet service, or the like through a communication network. According to an embodiment, the cellular module 221 may identify and authenticate the electronic device 201 within a communication network using the subscriber identification module 224 (for example, a SIM card). According to an embodiment, the cellular module 221 may perform at least some of the functions that the processor 210 may provide. According to an embodiment, the cellular module 221 may include a Communication Processor (CP).

Each of the Wi-Fi module 223, the Bluetooth module 225, the GNSS module 227, or the NFC module 228 may include, for example, a processor that processes data transmitted and received via a corresponding module. In some embodiments, at least some (two or more) of the cellular module 221, the Wi-Fi module 223, the Bluetooth module 225, the GNSS module 227, and the NFC module 228 may be included in a single Integrated Chip (IC) or IC package.

The RF module 229 may transmit/receive, for example, a communication signal (for example, an RF signal). The RF module 229 may include, for example, a transceiver, a power amplifier module (PAM), a frequency filter, a low-noise amplifier (LNA), an antenna, or the like. According to another embodiment, at least one of the cellular module 221, the Wi-Fi module 223, the BT module 225, the GPS module 227, and the NFC module 228 may transmit/receive an RF signal through a separate RF module.

The subscriber identification module 224 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 230 (for example, the memory 130) may include, for example, an internal memory 232 or an external memory 234. The internal memory 232 may include, for example, at least one of a volatile memory (e.g., a Dynamic Random Access Memory (DRAM), a Static RAM (SRAM), a Synchronous Dynamic RAM (SDRAM), etc.) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), etc.).

The external memory 234 may further include a flash drive, for example, a Compact Flash (CF), a Secure Digital (SD), a Micro-Secure Digital (Micro-SD), a Mini-Secure Digital (Mini-SD), an extreme Digital (xD), a Multi-Media Card (MMC), a memory stick, or the like. The external memory 234 may be functionally and/or physically connected to the electronic device 201 through various interfaces.

The sensor module 240 may, for example, measure a physical quantity or detect the operating state of the electronic device 201 and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, an illumination sensor 240K, and a ultraviolet (UV) sensor 240M. Additionally or alternatively, the sensor module 240A may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some embodiments, the electronic device 201 may further include a processor configured to control the sensor module 240 as a part of or separately from the AP 210, and may control the sensor module 240 while the AP 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. Furthermore, the touch panel 252 may further include a control circuit. The touch panel 252 may further include a tactile layer to provide a tactile reaction to a user.

The (digital) pen sensor 254 may include, for example, a recognition sheet that is a part of, or separate from, the touch panel. The key 256 may include, for example, a physical button, an optical key, or a keypad. The ultrasonic input device 258 may detect ultrasonic waves, which are generated by an input tool, through a microphone (for example, a microphone 288) to identify data corresponding to the detected ultrasonic waves.

The display 260 (for example, the display 160) may include a panel 262, a hologram device 264 or a projector 266. The panel 262 may have a configuration that is the same as, or similar to, that of the display 160 illustrated in FIG. 1. The panel 262 may be implemented to be, for example, flexible, transparent, or wearable. The panel 262, together with the touch panel 252, may be implemented as one module. The hologram device 264 may show a three dimensional image in the air by using an interference of light. The projector 266 may display an image by projecting light onto a screen. The screen may be located, for example, in the interior of, or on the exterior of, the electronic device 201. According to one embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication circuit 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280 may convert, for example, a sound into an electrical signal, and vice versa. At least some elements of the audio module 280 may be included, for example, in the input/output interface 145 illustrated in FIG. 1. The audio module 280 may process sound information that is input or output through, for example, a speaker 282, a receiver 284, earphones 286, the microphone 288, and the like.

The camera module 291 is a device that can photograph a still image and a dynamic image. According to an embodiment, the camera module 291 may include one or more image sensors (e.g., a front sensor or a rear sensor), a lens, an Image Signal Processor (ISP), or a flash (e.g., an LED, a xenon lamp, etc.).

The power management module 295 may manage, for example, the power of the electronic device 201. The electronic device 201 may be an electronic device that receives power from a battery, but it is not limited thereto. According to an embodiment, the power management module 295 may include a Power Management Integrated Circuit (PMIC), a charger Integrated Circuit (IC), or a battery or fuel gauge. The PMIC may use a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, the residual amount of the battery 296 and a voltage, current, or temperature while charging. The battery 296 may include, for example, a rechargeable battery and/or a solar battery.

The indicator 297 may display a particular state, for example, a booting state, a message state, a charging state, or the like of the electronic device 201 or a part (for example, the processor 210) of the electronic device 201. The motor 298 may convert an electrical signal into a mechanical vibration and may generate a vibration, a haptic effect, and the like. Although not illustrated, the electronic device 201 may include a processing unit (for example, a GPU) for supporting mobile TV. The processing unit for supporting the mobile TV may process media data according to a standard, such as Digital Multimedia Broadcasting (DMB), Digital Video Broadcasting (DVB), MediaFlo™, and the like.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

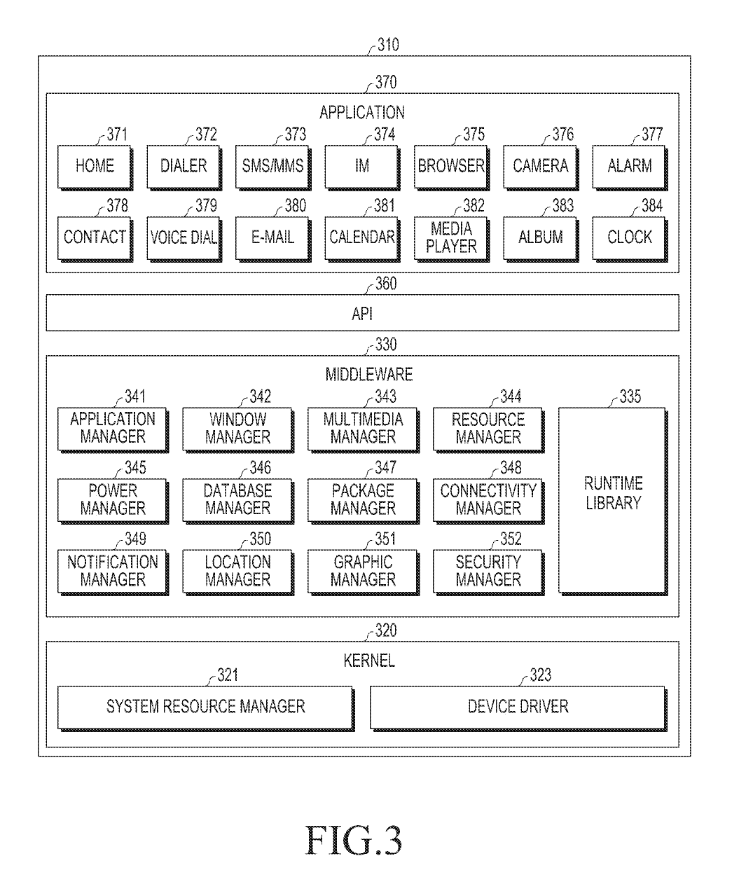

FIG. 3 is a block diagram of a program module according to various embodiments.

According to an embodiment, the program module 310 (e.g., the program 140) may include an Operating System (OS) that controls resources relating to an electronic device (e.g., the electronic device 101) and/or various applications (e.g., the application programs 147) running on the operating system. The operating system may be, for example, Android™, iOS™, Windows™, Symbian™, Tizen™, Bada™, etc.

The program module 310 may include a kernel 320, middleware 330, an Application Programming Interface (API) 360, and/or applications 370. At least a part of the program module 310 may be preloaded on the electronic device, or may be downloaded from an external electronic device (e.g., the electronic device 102 or 104, or the server 106).

The kernel 320 (for example, the kernel 141) may include, for example, a system resource manager 321 and/or a device driver 323. The system resource manager 321 may control, allocate, or retrieve system resources. According to an embodiment, the system resource manager 321 may include a process management unit, a memory management unit, or a file system management unit. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide, for example, a function required by the applications 370 in common, or may provide various functions to the applications 370 through the API 360 such that the applications 370 can efficiently use limited system resources within the electronic device. According to an embodiment, the middleware 330 (e.g., the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses in order to add a new function through a programming language while the applications 370 are being executed. The runtime library 335 may perform input/output management, memory management, the functionality for an arithmetic function, and the like.

The application manager 341 may manage, for example, the life cycle of at least one of the applications 370. The window manager 342 may manage Graphical User Interface (GUI) resources used on a screen. The multimedia manager 343 may determine formats required to reproduce various media files and may encode or decode a media file using a coder/decoder (codec) appropriate for the corresponding format. The resource manager 344 may manage resources, such as the source code, the memory, the storage space, and the like of at least one of the applications 370.

The power manager 345 may operate together with, for example, a Basic Input/Output System (BIOS) to manage a battery or power and provide power information required for the operation of the electronic device. The database manager 346 may generate, search for, or change a database to be used by at least one of the applications 370. The package manager 347 may manage the installation or update of an application that is distributed in the form of a package file.

The connectivity manager 348 may manage a wireless connection, such as Wi-Fi, Bluetooth, and the like. The notification manager 349 may display or provide notification of an event, such as an arrival message, an appointment, a proximity notification, or the like, in such a manner as not to disturb a user. The location manager 350 may manage the location information of the electronic device. The graphic manager 351 may manage a graphic effect to be provided to a user and a user interface relating to the graphic effect. The security manager 352 may provide various security functions required for system security, user authentication, and the like. According to an embodiment, when the electronic device (for example, the electronic device 101) has a telephone call function, the middleware 330 may further include a telephony manager that manages a voice or video call function of the electronic device.

The middleware 330 may include a middleware module that forms a combination of various functions of the above-described elements. The middleware 330 may provide specialized modules according to the types of operating systems in order to provide differentiated functions. Furthermore, the middleware 330 may dynamically remove some of the existing elements, or may add new elements.

The API 360 (for example, the API 145) is, for example, a set of API programming functions, and may be provided with different configurations according to operating systems. For example, in the case of Android or iOS, one API set may be provided for each platform, and in the case of Tizen, two or more API sets may be provided for each platform.

The applications 370 (for example, the application programs 147) may include, for example, one or more applications that are capable of providing functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measuring exercise quantity or blood sugar), environment information (for example, atmospheric pressure, humidity, or temperature information), and the like.

According to an embodiment, the applications 370 may include an application (hereinafter, referred to as an “information exchange application” for convenience of description) that supports information exchange between the electronic device (e.g., the electronic device 101) and an external electronic device (e.g., the electronic device 102 or 104). The information exchange application may include, for example, a notification relay application for transferring predetermined information to an external electronic device or a device management application for managing an external electronic device.

For example, the notification relay application may include a function of delivering, to the external electronic device (for example, the electronic device 103 or 104), notification information generated by other applications (for example, an SMS/MMS application, an email application, a health care application, an environmental information application, and the like) of the electronic device 101. Furthermore, the notification relay application, for example, may receive notification information from an external electronic device and may provide the received notification information to a user.

The device management application may manage (for example, install, delete, or update), for example, at least one function of an external electronic device (for example, the electronic device 102 or 104) that communicates with the electronic device (for example, a function of turning on/off the external electronic device itself (or some components thereof) or a function of adjusting the brightness (or resolution) of a display), applications that operate in the external electronic device, or services (for example, a call service, a message service, and the like) that are provided by the external electronic device.

According to an embodiment, the applications 370 may include applications (for example, a health care application of a mobile medical appliance, and the like) designated according to the attributes of an external electronic device (for example, the electronic device 102 or 104). According to an embodiment, the applications 370 may include applications received from an external electronic device (e.g., the server 106 or the electronic device 102 or 104). According to an embodiment, the applications 370 may include a preloaded application or a third party application that may be downloaded from a server. The names of the elements of the program module 310, according to the embodiment illustrated in the drawing, may vary according to the type of operating system.

According to various embodiments, at least a part of the programming module 310 may be implemented in software, firmware, hardware, or a combination of two or more thereof At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

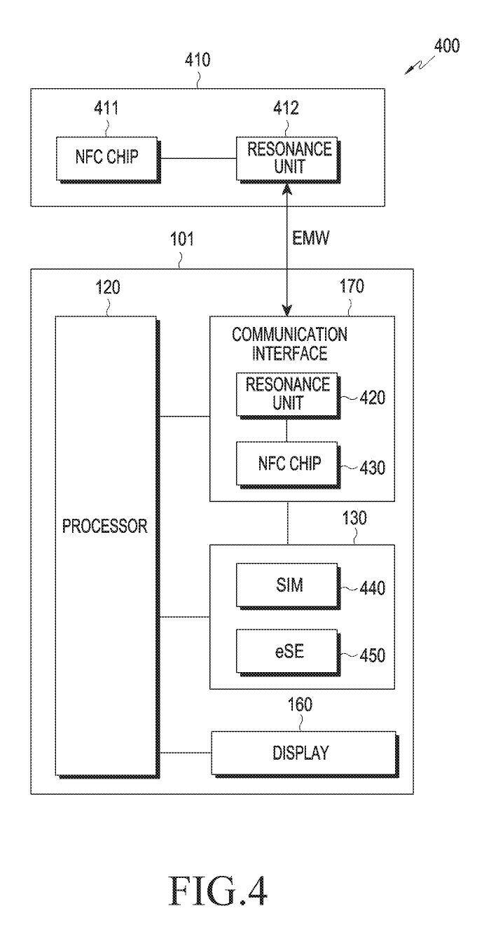

FIG. 4 is a block diagram illustrating a short-range wireless communication system (near field communication (NFC) system) according to various embodiments of the present disclosure.

Referring to FIG. 4, an NFC system 400 may include an NFC reader 410 and the electronic device 101. NFC technology is the contactless short-range wireless communication standard that enables electronic devices to perform wireless communication with low power using a frequency of 13.56 MHz within a short-distance less than or equal to 10 cm. The transmission speed per second of NFC is 424 Kbps, and NFC has excellent security based on the feature of proximity and encryption technology. In NFC, terminals are capable of recognizing each other within 1/10 seconds without a complex pairing procedure. Particularly, NFC technology is based on RFID technology. However, NFC technology has bidirectionality, has larger storage memory, and has a relatively wide applicable service range, when compared to a smart card.

NFC is a wireless communication scheme and a type of RFID scheme, by which terminals, for example, an NFC reader 410 and the electronic device 101, directly exchange data without using a communication network. The wireless communication scheme using RFID may be classified based on a frequency used. For example, the wireless communication scheme using RFID may include RFID of a 13.56 MHz band, which is mainly used for smart cards, such as transportation cards, access cards, or the like, and RFID of a 900 MHz band, which is mainly used for logistics. NFC corresponds to RFID that uses the frequency of the 13.56 MHz band, such as smart cards. However, unlike smart cards that are capable of performing communication in one direction, NFC may be capable of performing bidirectional communication, which is the crucial difference therebetween. Therefore, NFC is different from smart cards that only act as a tag that stores predetermined information and transmit the information to a reader. NFC may support a function of recording information in a tag as needed, in addition to performing the role of a tag, and may be used for performing peer-to-peer (P2P) information exchange between terminals containing NFC.

In the NFC system 400, the NFC reader 410 may include an NFC chip 411 and a resonance unit 412. The electronic device 101 may include the communication interface 170, the memory (or storage unit) 130, the display 160, and the processor 120. The communication interface 170 of the electronic device 101 may include a resonance unit 420 and an NFC chip 430. The memory (or storage unit) 130 of the electronic device 101 may include a SIM 440 and an embedded security element (eSE). The NFC reader 410 and the electronic device 101 in the NFC system 400 may communicate with each other on the basis of a near field communication (NFC) scheme. The electronic device 101 may perform data transmission and reception with the NFC reader 410 on the basis of electromagnetic waves (EMW) provided from the NFC reader 410 in a card mode in which the electronic device 101 operates as a card. The NFC reader 410 that operates in a reader mode may generate EMW, and may perform data transmission and reception with the electronic device 101 on the basis of the generated EMW.

The NFC reader 410 and the electronic device 101 may further include other elements needed for a payment service, in addition to the above-described elements.

The resonance unit 412 of the NFC reader 410 may receive an input message from the electronic device 101 (or the resonance unit 420) via EMW, and the NFC chip 411 of the NFC reader 410 may receive the input message from the resonance unit 412. The electronic device 101 may perform transmission and reception of signals or commands with the NFC chip 411 of the NFC reader 410 via the NFC chip 430. The resonance unit 412 of the electronic device 101 may transmit a message to the NFC reader 410 (or the resonance unit 412) via EMW, and the resonance unit 412 of the NFC reader 410 may transmit the message to the NFC chip 411. The resonance unit 412 of the NFC reader 410 may receive a message from the electronic device 101 (or the resonance unit 420) via EMW, and the NFC chip 411 of the NFC reader 410 may receive the message from the resonance unit 412. Alternatively, the NFC chip 411 of the NFC reader 410 may provide an output message (or at least one command) to the resonance unit 412 of the NFC reader 410, and the resonance unit 412 of the NFC reader 410 may transmit the output message to the electronic device 101 via EMW.

The resonance unit 412 of the NFC reader 410 provides, to the NFC chip 411, a signal derived in response to EMW received from the electronic device 101 (or the resonance unit 420), and the NFC chip 411 demodulates the signal and generates the input message, whereby the NFC reader 410 may perform a reception operation. The NFC chip 411 may provide a modulated signal generated by modulating the output message to the resonance unit 412, and the resonance unit 412 may reflect EMW received from the electronic device 101, on the basis of the modulated signal, thereby performing a transmission operation.

The NFC chip 411 may combine a carrier signal and the modulated signal obtained by modulating the output message and may provide the combined signal to the resonance unit 412 as a transmission signal, and the resonance unit 412 provides the transmission signal in the form of EMW to the electronic device 101, whereby the NFC reader 410 may perform a transmission operation. The resonance unit 412 may provide, to the NFC chip 411, a signal derived in response to EMW reflected from the electronic device 101, and the NFC chip 411 may demodulate the signal and may generate the input message, thereby performing a reception operation.

When performing a transmission operation in the card mode, the NFC chip 411 of the NFC reader 410 may adaptively change a radio frequency (RF) configuration parameter related to a transmission operation of the resonance unit 412, so as to remove a communication error that may occur during the transmission operation. Also, when performing a reception operation in the card mode, the NFC chip 411 of the NFC reader 410 may adaptively change an RF configuration parameter of the resonance unit 412, so as to remove a communication error that may occur during the reception operation.

The electronic device 101 may analyze a message received from the NFC reader 410, and may perform a payment process. The electronic device 101 may store at least one security element that is installed, in a part of the memory (or storage unit) 130. The security element (SE) may include a universal integrated circuit card (UICC), an embedded security element (eSE), and a host card emulation (HCE). The UICC may be serviced by a communication service provider that provides a communication service of the electronic device 101, and the eSE may be serviced by a manufacturer company of the electronic device 101. The electronic device 101 may install at least one security element that provides an Iso-Dep-based payment service. The electronic device 101 may store an Iso-Dep-based security element. The electronic device 101 may use a plurality of installed Iso-Dep-based security elements in parallel. The electronic device 101 may install at least one security element that provides a Mifare-based payment service. The electronic device 101 may store a Mifare-based security element. The electronic device 101 may use one installed Mifare-based security element. For example, when a Mifare-based eSE is activated, the use of a UICC based on Mifare may not be allowed.

When the electronic device 101 installs an applet for Mifare-based payment, the electronic device 101 parses a file and may determine whether a collision with the protocol of a previously installed Mifare-based applet occurs. The parsed information may be used to determine at least one of the protocol type, information associated with a security element, and the type of a Mifare-based security element that is currently set in the electronic device. For example, when a collision does not occur, the electronic device 101 may transfer a security element and a protocol corresponding to the applet for Mifare-based payment to the NFC chip 430, and may configure a routing table. The routing table may include information associated with a place where the security element and the protocol of at least one Mifare-based applet are stored or a path associated with the storage. For example, when a collision occurs, the electronic device 101 may output information indicating that a collision occurs via the display 160. When a collision occurs, the electronic device 101 may generate a popup so as to display the same via the display 160. The popup may include information indicating that a first security element based on Mifare and a second security element based on Mifare collide, and information for enabling one of the first security element and the second security element to be selected.

The NFC chip 430 may identify that a Mifare service is installed via a routing table, and may update an RF parameter so as to respond to the external NFC reader 410 (e.g., a Mifare-based reader). The electronic device 101 may configure a user interface for a plurality of security elements that are stored or installed. The user interface may be included by using an XML file or image (e.g., a banner image) obtained by parsing a signal (or command) received from the NFC reader 410. As described above, the electronic device 101 may configure a user interface including at least one Mifare-based security element, in addition to at least one Iso-Dep-based security element. In the case of Iso-Dep, all of the at least one Iso-Dep-based security element may be maintained in the activated state. However, in the case of Mifare, only one of the at least one Mifare-based security element may be activated for each time. Each of the security elements included in the user interface may include a checkbox such that a user makes a selection. A plurality of Iso-Dep-based security elements may be selected from among the at least one Iso-Dep-based security element included in the user interface. However, one Mifare-based security element may be selected from among the at least one Mifare-based security element.

In the case of installing an applet for Iso-Dep-based payment, when an application identifier (AID) and a space to which the applet is to be stored (e.g., SIM or eSE) are designated, the electronic device 101 may transfer the corresponding AID and a security element to the NFC chip 430 and may configure a routing table. The routing table may include information associated with a place where the security element and the AID of at least one Iso-Dep-based applet are stored or a path associated with the storage.

As described above, in the state in which a plurality of Iso-Dep-based security elements or Mifare-based security elements are installed, when a command is received from the NFC reader 410, the electronic device 101 may search the routing table and may transfer a command to an appropriate security element, thereby performing a follow-up operation that performs a payment operation.

When a collision with a previously installed Mifare-based applet occurs while a Mifare-based applet is installed, the electronic device 101 may display a popup via the display 160 so as to indicate that the collision occurred to a user. The popup may include a checkbox used for enabling one of the Mifare-based applets that collide to be selected, in addition to the indication reporting that the collision occurs. In the state in which a plurality of Iso-Dep-based security elements and a plurality of Mifare-based security elements are installed in the electronic device 101, when a command is received from the reader 410 via the communication interface 170, the electronic device 101 may analyze the received command so as to determine whether the reader 410 is based on Iso-Dep or Mifare. For example, when the reader 410 is based on Iso-Dep, the electronic device 101 may receive an application identifier (e.g., 11111) from the reader 410. For example, when the reader 410 is based on Mifare, the electronic device 101 may identify a protocol from the reader 410.

The electronic device 101 may parse payment information while installing a Mifare-based security element, and may identify whether a Mifare-based security element (e.g., a first security element) that is being installed collides with a previously installed Mifare-based security element (e.g., a second security element), on the basis of the parsed payment information. When the first security element and the second security element collide, the electronic device 101 may output a popup via the display. When the first security element is selected via the output popup, the electronic device 101 may configure a user interface and may configure a routing table including the first security element and a corresponding protocol. The first security element and the second security element may correspond to one selected from among a universal integrated circuit card (UICC), an embedded security element (eSE), and a host card emulation (HCE). The electronic device 101 may configure the user interface by including one selected from among the first security element and second security element which are based on Mifare, and at least one Iso-Dep-based security element that has been previously installed in the electronic device. The electronic device 101 may configure the user interface by including an image corresponding to each security element.

When a command is received from the NFC reader 410 via the communication interface 170, the electronic device 101 may analyze the received command and may determine a payment scheme of the electronic device. When the determined payment scheme is an Iso-Dep based payment scheme, the electronic device 101 may search the configured routing table, so as to determine a security element corresponding to an application identifier included in the received command, and may transfer the received command to the determined security element. When the determined payment scheme is a Mifare-based payment scheme, the electronic device 101 may search the configured routing table, so as to determine a security element corresponding to a protocol included in the received command, and may transfer the received command to the determined security element.

An electronic device, according to various embodiments of the present disclosure, may include a display, a storage unit configured to store a plurality of security elements, a communication interface configured to communicate with a near field communication (NFC) reader, and a processor. The processor may parse payment information while installing a first security element, may identify whether the first security element collides with a previously stored second security element, on the basis of the parsed payment information, may output a popup via the display when the first security element and the second security element collide, may configure a user interface when the first security element is selected via the output popup, and may configure a routing table including the first security element and a corresponding protocol.

According to an embodiment, the first security element and the second security element may correspond to a Mifare-based payment scheme.

According to an embodiment, the first security element and the second security element may correspond to one of a universal integrated circuit card (UICC), an embedded security element (eSE), and a host card emulation (HCE).

According to an embodiment, the parsed payment information may be used to determine at least one of the protocol type, information associated with a security element, and the type of a Mifare-based security element which is currently set in the electronic device.

According to an embodiment, the popup may include information indicating that the first security element and the second security element collide, and information for enabling one of the first security element and the second security element to be selected.

According to an embodiment, the processor may configure the user interface by including one of the first security element and the second security element, and at least one Iso-Dep-based security element which has been previously installed in the electronic device.

According to an embodiment, the processor may configure the user interface by including an image of each security element.

According to an embodiment, when a command is received from the NFC reader via the communication interface, the processor may analyze the received command and may determine a payment scheme of the electronic device.

According to an embodiment, when the determined payment scheme is an Iso-Dep-based payment scheme, the processor may search the configured routing table, so as to determine a security element corresponding to an application identifier included in the received command, and may transfer the received command to the determined security element.

According to an embodiment, when the determined payment scheme is a Mifare-based payment scheme, the processor may search the configured routing table, so as to determine a security element corresponding to a protocol included in the received command, and may transfer the received command to the determined security element.

According to an embodiment, the storage unit may include at least one of a subscriber identification module (SIM) card, a microSD, and an eSE.

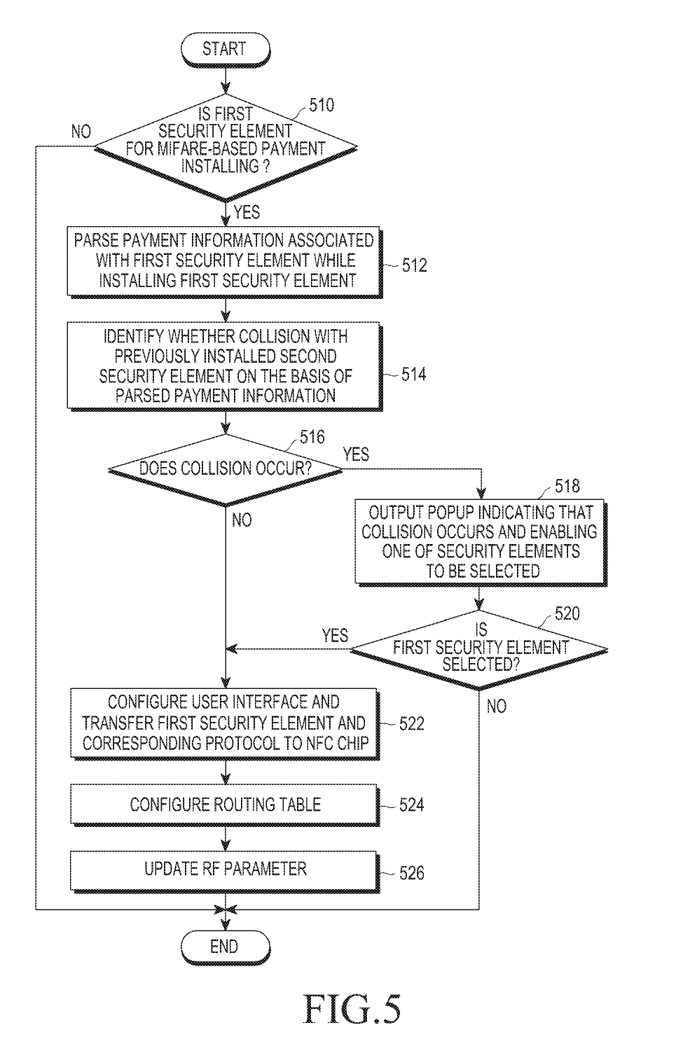

FIG. 5 is a flowchart illustrating a process of installing a security element for payment in an electronic device according to an embodiment of the present disclosure.

Hereinafter, referring to FIG. 5, a process of installing a security element for payment by an electronic device according to an embodiment of the present disclosure will be described as follows.

In operation 510, the electronic device 101 may install a first security element for Mifare-based payment. The electronic device 101 may install an applet for Mifare-based payment. The electronic device 101 may install at least one security element for Iso-Dep-based payment, in addition to the security element for Mifare-based payment. When a plurality of security elements for Iso-Dep based payment are installed in the electronic device 101, the electronic device 101 may activate and use the plurality of security elements for Iso-Dep-based payment. The electronic device 101 may install at least one security element for Mifare-based payment. When a plurality of security elements for Mifare-based payment are installed, the electronic device 101 may activate and use only one security element for Mifare-based payment, for one payment case. The security element may include at least one from among a UICC, an eSE, and an HCE.

In operation 512, the electronic device 101 may parse payment information associated with the first security element while installing the first security element. The electronic device 101 may parse the payment information while installing the first security element for Mifare-based payment. The parsed information may be used to determine at least one of the protocol type, information associated with a security element, and the type of a Mifare-based security element that is currently set in the electronic device.

In operation 514, the electronic device 101 may identify whether a collision occurs with a previously installed second security element, on the basis of the parsed payment information. The electronic device 101 may identify whether a Mifare-based security element (e.g., a first security element) that is being installed collides with a Mifare-based security element (e.g., a second security element) that has been previously installed and stored, on the basis of the parsed payment information.

When a collision occurs in operation 516, the electronic device 101 may output a popup so as to inform that the collision occurs and to enable one of the security elements to be selected, in operation 518. For example, when a collision occurs, the electronic device 101 may output information indicating that the collision occurs via the display 160. When a collision occurs, the electronic device 101 may generate a popup and display the same via the display 160. The popup may include information indicating that the first security element based on Mifare and the second security element based on Mifare collide, and information for enabling one of the first security element and the second security element to be selected.

In operation 520, the electronic device 101 may identify whether the first security element is selected. The electronic device 101 may identify whether a user selects the first security element that is being installed or the second security element that has been previously installed, via the output popup. In the case of a security element for Mifare-based payment, one security element may be selected for one case.

In operation 522, the electronic device 101 may configure a user interface configuration, and may transfer the first security element and a corresponding protocol to the NFC chip. When one Mifare-based security element is selected, the electronic device 101 may configure a user interface by including the selected Mifare-based security element and a plurality of Iso-Dep-based security elements. The electronic device 101 may transfer, to the NFC chip 430, a protocol corresponding to the first security element that is based on Mifare.

In operation 524, the electronic device 101 may configure a routing table. The electronic device 101 may configure the routing table including a protocol corresponding to the first security element that is based on Mifare. The routing table may include information associated with a place where the security element and the protocol of at least one Mifare-based applet are stored or a path associated with the storage. The routing table may include information associated with a place where the security element and the AID of at least one Iso-Dep-based applet are stored or a path associated with the storage.

In operation 526, the electronic device 101 may update an RF parameter. The electronic device 101 may identify that a Mifare service is installed via the routing table, and may update an RF parameter so as to respond to the external NFC reader 410 (e.g., a Mifare-based reader). After the routing table is generated (or updated), when a command is received from the NFC reader 410, the electronic device 101 may analyze the received command and may determine a payment scheme of the NFC reader 410. For example, when the determined payment scheme is an Iso-Dep based payment scheme, the electronic device 101 may search the configured routing table, so as to determine a security element corresponding to an application identifier included in the received command, and may transfer the received command to the determined security element. For example, when the determined payment scheme is a Mifare-based payment scheme, the electronic device 101 may search the configured routing table, so as to determine a security element corresponding to a protocol included in the received command, and may transfer the received command to the determined security element.

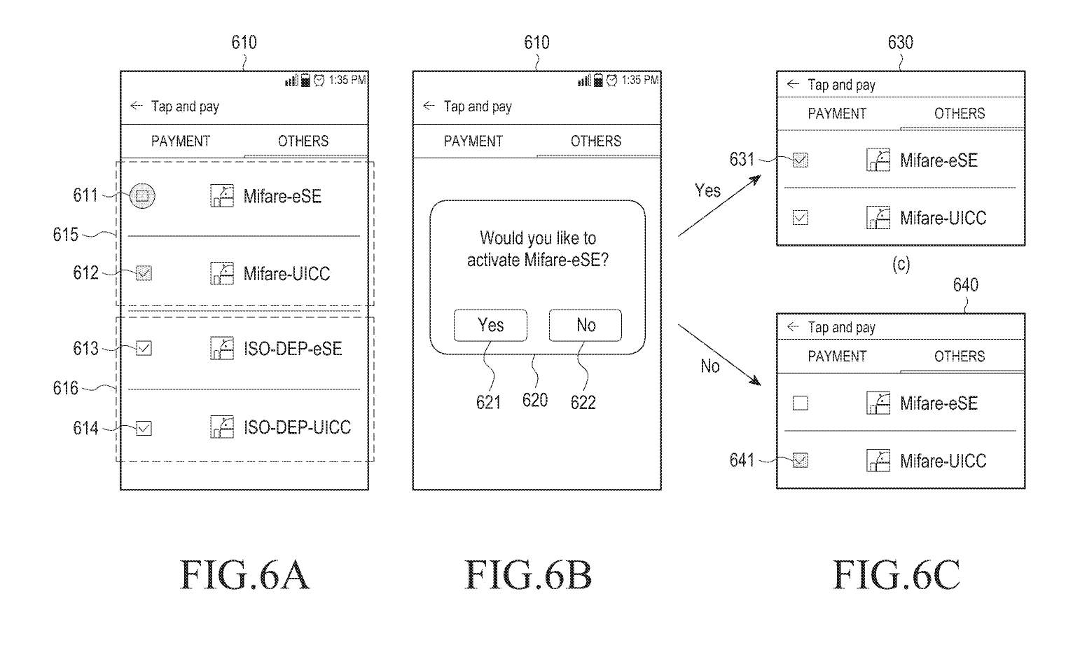

FIG. 6A is a diagram illustrating a user interface in which a plurality of Iso-Dep-based security elements and a plurality of Mifare-based security elements are illustrated according to an embodiment of the present disclosure. FIG. 6B is a diagram illustrating the case in which a collision with a previously installed security element occurs while a Mifare-based security element is installed according to an embodiment of the present disclosure. FIG. 6C is a diagram illustrating the case in which a Mifare-based security element is installed and is activated according to an embodiment of the present disclosure. FIG. 6D is a diagram illustrating the case in which a Mifare-based security element is installed, but is not activated according to an embodiment of the present disclosure.

Referring to FIGS. 6A to 6D, the electronic device 101 may install at least one Mifare-based security element, and may install at least one Iso-Dep-based security element. The electronic device 101 may configure a user interface 610 including one or more elements that are based on various installed payment schemes, and may display the configured user interface on the display 160. The user interface may include a screen 615 including at least one Mifare-based element and a screen 616 including at least one Iso-Dep-based element. The user interface may include a checkbox for enabling a user to select an element. For example, the screen 615 that includes at least one Mifare-based element may include an eSE and a UICC. The eSE and the UICC are elements which have been previously installed. The screen 615 including at least one Mifare-based element may include a checkbox 611 to select the eSE and a checkbox 612 to select the UICC. The eSE and the UICC, which have been previously installed in the screen 615 including the at least one Mifare-based element, may be selected in parallel.

The screen 616 that includes at least one Iso-Dep-based element may include an eSE and a UICC. The eSE and the UICC are elements which have been previously installed. The screen 616 including at least one Iso-Dep-based element may include a checkbox 613 to select the eSE and a checkbox 614 to select the UICC. Only one of the eSE and the UICC, which have been previously installed in the screen 616 including the at least one Iso-Dep-based element, may be selected.

For example, in the state in which a Mifare-based element (e.g., UICC) has been previously installed in the electronic device 101, when a Mifare-based element (e.g., eSE) is being installed, the electronic device 101 may determine that the Mifare-based eSE that is being installed collides with the UICC that has been previously installed. The electronic device 101 may parse payment information while installing the eSE, and may determine whether a collision with the previously installed UICC occurs. When it is determined that a collision occurs, the electronic device 101 may output a popup 620. When a collision occurs, the electronic device 101 may output information indicating that the collision occurs via the display 160. The popup may include information indicating that the Mifare-based UICC and the Mifare-based eSE collide, and information for enabling one of security elements from among the UICC and the eSE to be selected. For example, when a collision occurs while the Mifare-based eSE is installed, the electronic device 101 may display the popup 620. When an input 621 for activating the installed eSE is received from a user via the popup 620, the electronic device 101 may display a check mark put in the checkbox 631 of the newly installed Mifare-based eSE, as shown in FIG. 6C, in order for activation. Subsequently, Mifare-based payment may be performed via the eSE. For example, when an input 622 for deactivating the installed eSE or that does not agree with the activation of the eSE is received via the popup 620, the electronic device 101 may display a check mark put in the checkbox 641 of the previously installed Mifare-based UICC, as shown in FIG. 6D, in order for activation. Subsequently, Mifare-based payment may be performed via the UICC.

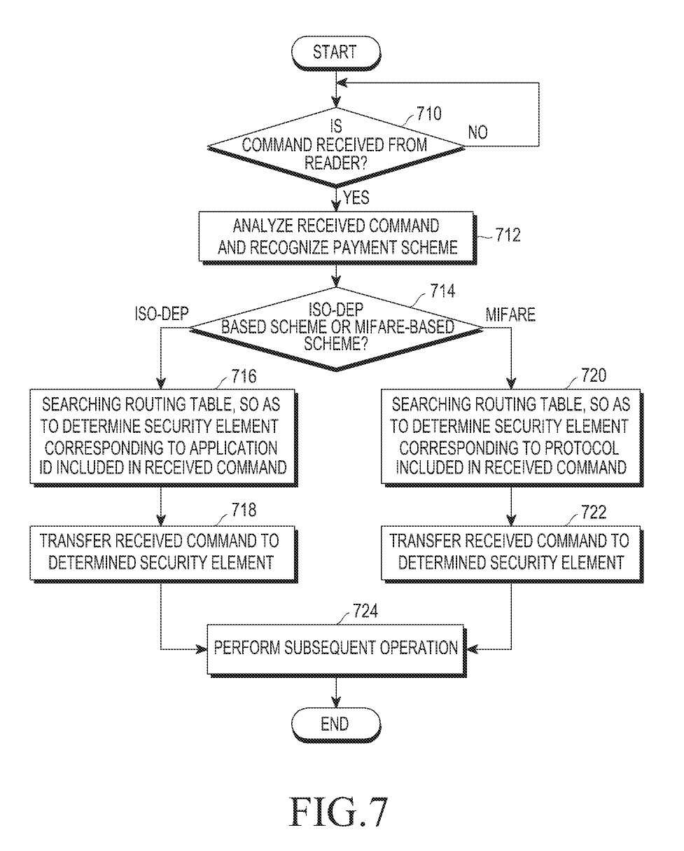

FIG. 7 is a flowchart illustrating a process in which an electronic device provides a payment service according to an embodiment of the present disclosure.

Hereinafter, referring to FIG. 7, a process of providing a payment service by an electronic device according to an embodiment of the present disclosure will be described as follows.

In operation 710, the electronic device 101 may receive a command from a reader. The NFC reader and the electronic device 101 may mutually communicate with each other on the basis of an NFC scheme. In a card mode in which the electronic device 101 operates as a card, the electronic device 101 may perform data transmission and reception with the NFC reader on the basis of electromagnetic waves provided from the NFC reader. The NFC reader that operates in a reader mode may generate electromagnetic waves and may perform data transmission and reception with the electronic device 101 on the basis of the generated electromagnetic waves. The electronic device 101 may perform transmission and reception of signals or commands with the NFC chip 411 of the NFC reader 410 via the NFC chip 430. The resonance unit 420 of the electronic device 101 may transmit a message to the NFC reader 410 (or the resonance unit 412) via electromagnetic waves, and may receive a message (or a command) from the resonance unit 412 of the NFC reader 410.

In operation 712, the electronic device 101 may analyze the received command and may recognize a payment scheme. When a command is received from the NFC reader 410 via the communication interface 170, the electronic device 101 may analyze the received command and may determine a payment scheme of the electronic device. The electronic device 101 may search a routing table on the basis of an application identifier included in the received command The electronic device 101 may search the routing table, so as to determine a security element suitable for the command.

In operation 714, the electronic device 101 may analyze the command received from the reader and may determine whether the reader is based on an Iso-Dep-based payment scheme or a Mifare-based payment scheme. When the command is received from the NFC reader 410, the electronic device 101 may analyze the received command and may determine whether the payment scheme of the electronic device is based on the Iso-Dep-based payment scheme or the Mifare-based payment scheme.

In operation 716, the electronic device 101 may search the routing table, so as to determine a security element corresponding to an application identifier included in the received command. When the result of the analysis on the command received from the NFC reader 410 shows that the payment scheme of the electronic device is based on the Iso-Dep-based payment scheme, the electronic device 101 may search the routing table, so as to determine a security element corresponding to the application identifier included in the received command. The electronic device 101 may search the routing table, so as to determine information associated with a place where the security element and the AID of at least one Iso-Dep-based applet are stored or a path associated with the storage.

In operation 718, the electronic device 101 may transfer the received command to the determined security element. The electronic device 101 may transfer the command received from the reader to a place where the determined Iso-Dep-based security element is stored.

In operation 720, the electronic device 101 may search the routing table, so as to determine a security element corresponding to a protocol included in the received command The electronic device 101 may search the routing table, so as to determine the security element corresponding to the protocol included in the received command When the result of the analysis on the command received from the NFC reader 410 shows that the payment scheme of the electronic device is based on the Mifare-based payment scheme, the electronic device 101 may search the routing table, so as to determine a security element corresponding to the protocol included in the received command The electronic device 101 may search the routing table, so as to determine information associated with a place where the security element of at least one Mifare-based applet is stored or a path associated with the storage.

In operation 722, the electronic device 101 may transfer the received command to the determined security element. The electronic device 101 may transfer the command received from the reader to a place where the determined Mifare-based security element is stored.

In operation 724, the electronic device 101 may perform a subsequent operation. The electronic device 101 may search the routing table and may transfer the command to the appropriate security element, thereby performing a follow-up operation to perform a payment operation.

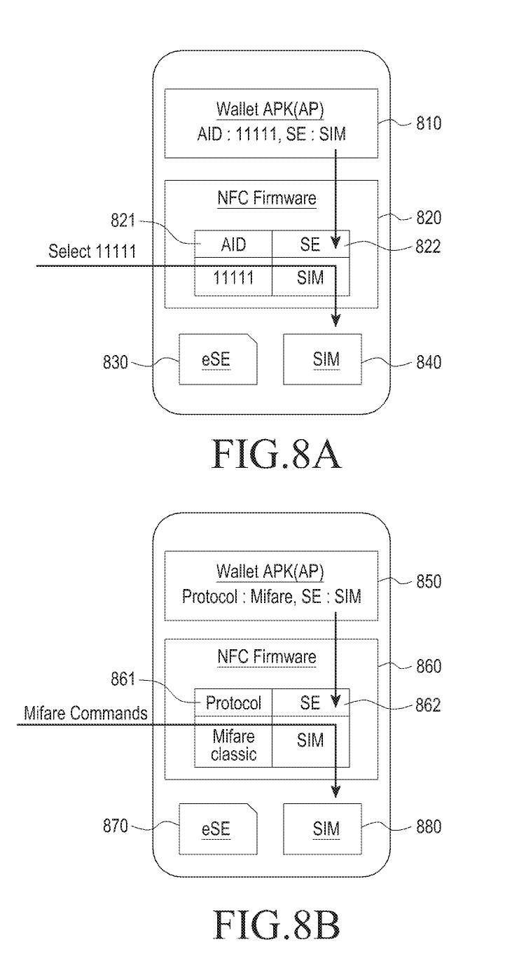

FIG. 8A is a diagram illustrating an Iso-Dep-based payment service by an electronic device according to an embodiment of the present disclosure. FIG. 8B is a diagram illustrating an Iso-Dep-based payment service by an electronic device according to an embodiment of the present disclosure.

Referring to FIG. 8A, an electronic device according to an embodiment of the present disclosure may provide an Iso-Dep-based payment service. When a command is received from the NFC reader 410 via the communication interface 170, the electronic device 101 may analyze the received command and may determine a payment scheme of the electronic device. The electronic device 101 may analyze the command received from the reader and may determine whether the reader is based on an Iso-Dep-based payment scheme or a Mifare-based payment scheme.

The electronic device 101 may add (or update) an application identifier 821 corresponding to a security element of an Iso-Dep-based applet 810 and a security element 822 to a routing table of an NFC chip 820. The routing table may include application identifiers of a plurality of Iso-Dep-based applets installed in advance in the electronic device 101 and a security element. The electronic device 101 may search the routing table of the NFC chip 820 on the basis of the received command, so as to determine the security element 822 corresponding to the application identifier 821 included in the received command The electronic device 101 may search the routing table, so as to determine information associated with a place where the security element and the AID of at least one Iso-Dep-based applet are stored or a path associated with the storage. The electronic device 101 may transfer the command received from the reader to a place where the determined Iso-Dep-based security element is stored. For example, when the result of searching the routing table on the basis of the command received from the reader shows that an application identifier is “11111” and the security element is stored in a SIM 840, the electronic device 101 may transfer the command received from the reader to the SIM 840. For example, when the result of searching the routing table on the basis of the command received from the reader shows that an application identifier is “11111” and the security element is an eSE 830, the electronic device 101 may transfer the command received from the reader to a place where the eSE 830 is stored. The electronic device 101 may perform a subsequent operation in order to provide a payment service.

Referring to FIG. 8B, an electronic device according to an embodiment of the present disclosure may provide a Mifare-based payment service. When a command is received from the NFC reader 410 via the communication interface 170, the electronic device 101 may analyze the received command and may determine a payment scheme of the electronic device. The electronic device 101 may analyze the command received from the reader and may determine whether the reader is based on an Iso-Dep-based payment scheme or a Mifare-based payment scheme.

The electronic device 101 may add (or update) a protocol 861 corresponding to a security element of a Mifare-based applet 850 and a security element 862 to a routing table of an NFC chip 860. The routing table may include protocols of a plurality of Mifare-based applets installed in advance in the electronic device 101 and a security element. The electronic device 101 may search the routing table of the NFC chip 860 on the basis of the received command, so as to determine the security element 862 corresponding to the protocol 861 included in the received command. The electronic device 101 may search the routing table, so as to determine information associated with a place where the security element and the at least one Mifare-based protocol are stored or a path associated with the storage. The electronic device 101 may transfer the command received from the reader to a place where the determined Mifare-based security element is stored. For example, when the result of searching the routing table on the basis of the command received from the reader shows that a protocol is “Mifare classic” and the security element is stored in a SIM 880, the electronic device 101 may transfer the command received from the reader to the SIM 880. For example, when the result of searching the routing table on the basis of the command received from the reader shows that a protocol is “Mifare classic” and the security element is an eSE 870, the electronic device 101 may transfer the command received from the reader to a place where the eSE 870 is stored. The electronic device 101 may perform a subsequent operation in order to provide a payment service.

The term “module” as used herein may, for example, mean a unit including one of hardware, software, and firmware or a combination of two or more of them. The “module” may be interchangeable with a term, such as a unit, a logic, a logical block, a component, or a circuit. The “module” may be a minimum unit of an integrated component element or a part thereof The “module” may be a minimum unit for performing one or more functions or a part thereof The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. When the command is executed by control circuits, the control circuits may perform a function corresponding to the command The computer-readable storage medium may, for example, be the memory 130. At least some of the programming modules may be implemented (for example, executed) by, for example, the processor. At least some of the programming modules may include, for example, a module, a program, a routine, a set of instructions or a process for performing one or more functions.

The computer readable recording medium may include magnetic media such as a hard disc, a floppy disc, and a magnetic tape, optical media such as a compact disc read only memory (CD-ROM) and a digital versatile disc (DVD), magneto-optical media such as a floptical disk, and hardware devices specifically configured to store and execute program commands, such as a read only memory (ROM), a random access memory (RAM), and a flash memory. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner Furthermore, some operations may be executed in a different order or may be omitted, or other operations may be added. According to various embodiments, there is provided a storage medium storing instructions, wherein the instructions may include: a first instruction set for parsing payment information while installing a first security element; a second instruction set for identifying whether the first security element collides with a previously stored second security element on the basis of the parsed payment information; a third instruction set for outputting a popup when the first security element and the second security element collide; a fourth instruction set for configuring a user interface when the first security element is selected via the output popup; and a fifth instruction set for configuring a routing table including the first security element and a corresponding protocol.

Exemplary embodiments of the present disclosure shown and described in this specification and the drawings correspond to specific examples presented in order to easily describe technical contents of the present disclosure and to help comprehension of the present disclosure, and are not intended to limit the scope of the present disclosure. Therefore, it should be construed that, in addition to the embodiments disclosed herein, all modifications and changes or modified and changed forms derived from the technical idea of the present disclosure fall within the scope of the present disclosure.

1. An electronic device for providing a payment service, the electronic device comprising:
a display;
a storage unit configured to store a plurality of security elements;
a communication interface configured to communicate with a near field communication (NFC) reader; and
a processor,
wherein the processor is configured to perform:
parsing payment information while installing a first security element,
identifying whether the first security element collides with a previously
stored second security element, on the basis of the parsed payment information,
outputting a popup via the display when the first security element and the second security element collide,
configuring a user interface when the first security element is selected via the output popup, and
configuring a routing table including the first security element and a corresponding protocol.

2. The electronic device of claim 1, wherein the first security element and the second security element correspond to a Mifare-based payment scheme.

3. The electronic device of claim 1, wherein the first security element and the second security element correspond to one of a universal integrated circuit card (UICC), an embedded security element (eSE), and a host card emulation (HCE).

4. The electronic device of claim 1, wherein the parsed payment information is used to determine at least one of a protocol type, information associated with a security element, and a type of a Mifare-based security element which is currently set in the electronic device.

5. The electronic device of claim 1, wherein the popup comprises information indicating that the first security element and the second security element collide, and information for enabling one of the first security element and the second security element to be selected.

6. The electronic device of claim 1, wherein the processor configures the user interface by including one of the first security element and the second security element and at least one Iso-Dep-based security element previously installed in the electronic device.

7. The electronic device of claim 6, wherein the processor configures the user interface by including an image of each security element.

8. The electronic device of claim 1, wherein, when a command is received from the NFC reader via the communication interface, the processor analyzes the received command and determines a payment scheme of the electronic device.

9. The electronic device of claim 8, wherein, when the determined payment scheme is an Iso-Dep-based payment scheme, the processor performs:
searching the configured routing table, so as to determine a security element corresponding to an application identifier included in the received command, and transferring the received command to the determined security element.

10. The electronic device of claim 8, wherein, when the determined payment scheme is a Mifare-based payment scheme, the processor may perform:
searching the configured routing table, so as to determine a security element corresponding to a protocol included in the received command, and
transferring the received command to the determined security element.

11. The electronic device of claim 1, wherein the storage unit comprises at least one of a subscriber identification module (SIM) card, a microSD, and an eSE.

12. A method of providing payment by an electronic device, the method comprising:
parsing payment information while installing a first security element;
identifying whether the first security element collides with a previously stored second security element, on the basis of the parsed payment information;
outputting a popup when the first security element and the second security element collide;
configuring a user interface when the first security element is selected via the output popup; and
configuring a routing table including the first security element and a corresponding protocol.

13. The method of claim 12, wherein the first security element and the second security element correspond to a Mifare-based payment scheme.

14. The method of claim 12, wherein the parsed payment information is used to determine at least one of a protocol type, information associated with a security element, and a type of a Mifare-based security element which is currently set in the electronic device.

15. The method of claim 12, wherein the popup comprises information indicating that the first security element and the second security element collide, and information for enabling one of the first security element and the second security element to be selected.
